(19) United States
(12) Patent Application Publication
(10) Pub. No.: US 2025/0298723 A1
(43) Pub. Date: Sep. 25, 2025

(54) METHOD FOR EXECUTING A DEBUGGING PROCESS OF A CONTROL PROGRAM OF AN AUTOMATION SYSTEM

(71) Applicant: Beckhoff Automation GmbH, Verl (DE)

(72) Inventor: Ralf Dreesen, Rietberg (DE)

(21) Appl. No.: 19/189,459

(22) Filed: Apr. 25, 2025

Related U.S. Application Data
(63) Continuation of application No. PCT/EP2023/081335, filed on Nov. 9, 2023.

(30) Foreign Application Priority Data
Nov. 10, 2022 (DE) 10 2022 129 772.1

(51) Int. Cl. G06F 11/362

(52) U.S. Cl. CPC G06F 11/3624

(57) ABSTRACT

A method for executing a debugging process of a control program of an automation system includes receiving a first machine code source code relation and a first source code identity, by a development system for executing the debugging process, in a receiving step; comparing the first source code identity with a second source code identity of a second source code version executed on the development system, in a source code comparing step; generating a version identity based on the comparison of the source code identities, in an identity generating step; determining a second machine code source code relation based on the first machine code source code relation and the version identity, in a relation determining step; and executing the debugging process of the machine code stored on the controller based on the second source code version, using the second machine code source code relation, in a debugging step.

### CROSS-REFERENCE TO RELATED APPLICATIONS

This application is a continuation of International Patent Application PCT/EP2023/081335, filed Nov. 9, 2023, entitled “Method for Executing a Debugging Process of a Control Program of an Automation System,” which claims priority to German Patent Application DE 10 2022 129 772.1, filed Nov. 10, 2022, entitled “Verfahren zum Ausführen eines Debugging-Vorgangs eines Steuerprogramms eines Automatisierungssystems,” each of which is incorporated by reference herein, in the entirety and for all purposes.

### FIELD

The application provides a method for executing a debugging process of a control program of an automation system.

### BACKGROUND

Programmable logic controllers (PLCs) are predominantly used to control and regulate machines and systems, particularly in the automation industry. The control or regulation behavior is expressed by correspondingly configured control programs that may be executed on the respective PLC. Such control programs are usually developed individually by a developer for the respective machine or system type.

In order to test the behavior of the control program, an incomplete but executable control program is frequently installed and executed on the PLC by the developer at an early stage. During execution, the control of the machine or system may be observed and the control program may be improved by making changes to the program based on the knowledge gained.

In order to gain knowledge (e.g. for error analysis), control programs can be observed and controlled by developers with tools (debuggers) during their execution on a control system. For this purpose, developers usually has access to the source code of the executed control program, which is usually stored on the development system they are executing.

In order to examine the functionality of the control program, the developer may set so-called holding points to execute the control program piece by piece, in which the control program is put on hold at each holding point. In this state, the developer may inspect variables and continue the execution step by step, i.e. program line by program line, and thus check intermediate results of the control program. The current position of the interruption during execution is always marked in the source code display. These basic functions are provided by standard development tools.

However, problems may occur if the source code on the development system differs from the source code from which the currently running control program was compiled. Therefore, the application provides an improved method for executing a debugging process of a control program of an automation system.

### SUMMARY

According to an aspect of the application, a method for executing a debugging process of a control program of an automation system is provided, said method comprising:
receiving a machine code source code relation and a first source code identity by a development system for carrying out the debugging process in a receiving step, wherein the machine code source code relation defines associations between lines of a first version of a source code of the control program and corresponding code elements of a machine code of the control program generated by translation of the first source code version, and wherein the first source code identity comprises information relating to the first source code version which allows for identifying individual lines of the first source code version;
comparing the first source code identity to a second source code identity of a second source code version executed on the development system in a source code comparing step, wherein the second source code version has emerged from the first source code version by at least one source code change, and wherein the second source code identity comprises information relating to the second source code version which allows for identifying individual lines of the second source code version;
generating a version identity based on the comparison of the first source code identity and the second source code identity in an identity generating step, wherein the version identity defines allocations between lines of the first source code version and lines of the second source code version corresponding to the lines of the first version;
determining a second machine code source code relation based on the first machine code source code relation and the version identity in a relation determining step, wherein the second machine code source code relation defines allocations between lines of the second source code version and corresponding code elements of the machine code; and
executing the debugging process of the machine code stored on the controller based on the second source code version using the second machine code source code relation in a debugging step.

This may achieve the technical advantage of providing an improved method for executing a debugging process of a control program of an automation system. In particular, the improved method may be used to execute a debugging process of a control program that is executed on a version of a source code of the control program that does not correspond to the version of the translated and executable machine code of the control program.

### EXAMPLES

In particular, the method according to the application may cover the case where a machine code of a control program has been generated by a translation process of a first version of a source code. By making changes to the first source code version, a second source code version has subsequently been generated. The second source code version therefore does not match the generated version of the machine code.

Conventional debugging processes are not able to execute debugging processes of the respective program based on source code that deviates from the respective machine code. According to the application, this problem is solved by additionally providing a first source code identity in addition to a first machine code source code relation, which is generated during the translation process of the first source code version and defines allocations between lines of the first source code version of the control program and corresponding code elements of the machine code generated by translation. The first source code identity provides information relating to the first source code version, which makes it possible to identify individual lines of the first source code version.

Furthermore, a second source code identity is provided based on the second source code version, which differs from the first source code version and, analogous to the first source code identity, provides information relating to the second source code that allows for identifying individual lines of the second source code.

The two source code identities of the first source code version and the second source code version are then compared to each other and a version identity is generated. The version identity defines allocations between the lines of the first source code version and the lines of the second source code version.

The version identity hereby identifies the lines that match in the first source code version and in the second source code version. It also identifies the lines in the first source code version and the second source code version that do not match in the other source code version.

Based on the first machine code source code relation and the version identity, a second machine code source code relation is then determined. The second machine code source code relation defines allocations between lines of the second source code version and corresponding code elements of the machine code.

A clear connection between the lines of the second source code version and the elements of the machine code is therefore known via the second machine code source code relation. The second machine code source code relation thus uniquely identifies the lines of the second source code version that have a correspondence in the machine code and the lines of the second source code version that have no correspondence in the machine code. Based on the second machine code source code relation, a corresponding debugging process of the control program may thus be executed using the second source code version.

The method according to the application may thus be used to execute debugging processes of control programs that are carried out on source code versions of the control program that do not correspond to the respective machine codes of the control program.

This is e.g. advantageous for debugging processes during the programming process of the control program. In order to execute the debugging process, it is therefore not necessary to recompile the source code into corresponding machine code each time the source code is changed.

Instead, the debugging process may be carried out on the existing machine code, even if the corresponding source code has already been modified in the current version. This simplifies the programming process.

In addition, the method according to the application makes it possible to carry out debugging processes in which the programming process is split up, for example, between different developers who develop the control program in different development environments or development systems. If the developers work on different source code versions, since a new translation of the source code into corresponding machine code would not be carried out each time the source code is changed, the individual developers may nevertheless carry out a meaningful debugging process of the already generated control program from the different development systems, based on the different source code versions.

In particular, improved control programs may be provided by executing the debugging process. This may result in improved, more efficient and safe control of the automation system.

### BRIEF DESCRIPTION OF THE DRAWINGS

The invention is described in more detail with reference to the attached figures, in which:

FIG. 1 shows a schematic depiction of an automation system;

FIG. 2 is a flowchart of a method for executing a debugging process according to an embodiment;

FIG. 3 is a further flowchart of a method for executing a debugging process according to a further embodiment;

FIG. 4 is a further flowchart of a method for executing a debugging process according to a further embodiment; and

FIG. 5 shows a further flowchart of a method for executing a debugging process according to a further embodiment.

### DETAILED DESCRIPTION

For the purposes of the application, a development system 300 is a development environment for developing source code. Such a development system may be provided, for example, by an IDE (intelligent development engine).

A development system, such as that used in automation technology, provides a developer of automation software with various functions for programming such software. In the case of text-based programming languages from DIN 61131, these include, for example, the auto-completion of frequently used programming expressions or similar. In the case of graphical programming languages from DIN 61131, the development system provides the graphical depiction of said programming.

A development system may therefore be used by developers of software products to develop control programs for machines or automation systems and other technical systems. Developers may use different programming languages for this purpose. In the automation sector, programming languages from DIN 61131 are primarily used. These may also include graphical programming languages.

Development systems may also be used by developers to observe and understand the behavior of programmed control programs during execution, for example to analyze errors or optimize behavior. This is achieved in debugging processes.

Development systems may also be used by technicians in order to operate an installation, for example an automation system. This may include transferring a control program to a corresponding controller, for example a PLC-programmable logic controller, and setting system parameters or observing the system behavior as described above in order to rule out or detect installation errors.

Development systems may also be used by operators of a technical system, for example an automation system, to control the system, operate it manually, bypass behavior or set simple parameters. A control program is usually formulated in one or more of the languages of the IEC 61131-3 standard.

The standard comprises five languages: “Structured text”, “Instruction list”, “Sequential function chart”, “Ladder diagram” and “Function block language”. “Structured text” and “Instruction list” are textual languages. “Ladder diagram” and “Function block language” are graphical languages. “Ladder Diagram” includes both textual and graphical aspects.

The input of source code during programming may be supported by an auto-completion mechanism within the development system used. The autocompletion may, for example, complete the input of a keyword, correct it and/or insert another allocated keyword.

Input may also be made easier by displaying information. For example, expected parameters of a function call may be displayed. If program code is detected as faulty (during input), the corresponding point within the source code may be highlighted and an optional explanation may be displayed, making it easier to rectify errors immediately.

According to an embodiment, the first source code identity comprises the first source code version and the second source code identity comprises the second source code version. This has the technical advantage that a precise allocation between the first and second source code versions may be achieved via the first and second source code identities. For this purpose, the first and second source code identities comprise the respective first and second source code versions.

By comparing the first and second source code identities as described above and generating the version identity, it is thus possible to determine exactly which lines of the second source code version correspond to which lines of the first source code version based on the first and second source code versions, or which lines of the second source code version have no correspondence in the first source code version.

By using the first and second source code versions as source code identities, a precise version identity may be provided. This in turn may be used to create a precise second machine code source code relation, in that the exact allocation of the lines of the second source code version to the lines of the first source code version allows for precisely allocating the lines of the second source code version to the respective elements of the machine code.

According to an embodiment, the first source code identity comprises a first encrypted source code version based on an encryption of the first source code version, the method further comprising:

encrypting the second source code version and generating a second encrypted source code version in an encrypting step, wherein the second source code identity comprises the second encrypted source code version; and wherein comparing the first and second source code identities comprises comparing the first and second encrypted source code versions.

This has the technical advantage that the encryption of the first and of the second source code versions allows for increased data security. First and second encrypted source code versions of the first and second source code versions are provided for this purpose.

In this context, the first source code identity accordingly comprises the first encrypted source code version, which is based on an encryption of the first source code version. By not using the actual first source code version for the first source code identity, but an encrypted version of the first source code version, the first source code identity may also be stored on the controller of the automation system in addition to the machine code based on the machine code source code relation.

By storing only an encrypted source code version in the form of the first encrypted source code version of the first source code identity on the controller of the automation system, it may be prevented that the source code of the control program is accessible to users of the automation system.

During operation of the automation system by a user, the first source code identity in the form of the first encrypted source code version may thus remain stored on the controller. If the control program is further developed by programming processes, the developer may therefore access the first source code identity stored on the controller and obtain information about the lines of the first source code version. The risk that the source code of the control program may be read by the user of the automation system does not exist due to the encryption of the first source code version within the first source code identity.

The method described above for determining the second machine code source code identity and the allocations between the lines of the second source code version and the corresponding elements of the machine code stored on the controller may be carried out analogously by the encryptings of the first and second source code versions.

For this purpose, a second encrypted source code version is first generated by encrypting the second source code version. Furthermore, a second source code identity is generated, which includes the second encrypted source code version and provides information regarding the lines of the second source code version.

Similarly, the first source code identity that may be stored on the controller of the automation system comprises the aforementioned first encrypted source code version. By comparing the first and second source code identities, in which the first encrypted source code version is compared with the second encrypted source code version, allocations between the lines of the first encrypted source code version and the lines of the second encrypted source code version may be achieved analogously to the embodiment described above.

Based on this, the version identity may be generated, which in this case defines the allocation between the encrypted lines of the first encrypted source code version and the encrypted lines of the second encrypted source code version. Based on this, the second machine code source code relation may be determined, in which the allocation between the lines of the second source code version and the corresponding elements of the machine code is defined.

In this context, it is assumed that the encrypted lines of the first encrypted source code version are related to the lines of the first source code version and the encrypted lines of the second encrypted source code version are related to the unencrypted lines of the second source code version.

According to an embodiment, the first and second source code versions are encrypted line by line. This may achieve the technical advantage that a precise allocation of the unencrypted lines of the first source code version and the encrypted lines of the first encrypted source code version and a precise allocation of the unencrypted lines of the second source code version and the encrypted lines of the second encrypted source code version is possible.

By encrypting the first and second source code versions line by line, the line order of the respective source code versions may be retained. In this way, a unique line-by-line allocation of the second source code version to the respective elements of the machine code may be achieved via the two encrypted source code versions by comparing the encrypted lines of the first and of the second source code versions with each other, as described above, and determining the respective relationships between the first source code version and the second source code version.

By encrypting the first source code version, this allows increased data security, as the first source code identity stored on the controller of the automation system cannot be read by uninvolved or unauthorized persons and conclusions may be drawn about the original source code. The line-by-line encryption nevertheless makes it possible to achieve a precise allocation between the two different source code versions, so that a precise allocation between individual lines of the second source code version and the respective elements of the machine code stored on the controller of the automation system may be achieved on this basis.

This allows for easy debugging of the control program during operation of the automation system based on a modified source code version. This in turn allows for smoothly and safely controlling the automation system.

According to an embodiment, the encryption of the first and second source code versions is embodied as a binary encryption. This allows the technical advantage of the simplest possible encryption of the first and second source code versions to be achieved.

Examples of binary encryption are RSA encryption (Rivest-Shamir-Adleman) or AES encryption (Advanced Encrypted Standard). Both encryption methods use a key to convert data into a form that may only be traced back to the original data if the key is known. In symmetric encryption, the same key is used for encryption and decryption. In asymmetric encryption, on the other hand, separate and different keys are used for encryption and decryption.

Both methods consider a sequence of bytes as input and return an (encrypted/decrypted) sequence of bytes, where a byte is an integer in the interval [0 . . . 255]. Each text is interpreted as a sequence of bytes and may therefore be encrypted directly. However, the result is a sequence of bytes that usually does not correspond to a valid line of text.

According to an embodiment, comparing the first and second encrypted source code versions in the identity generating step comprises comparing the encrypted lines of the first and second encrypted source code versions line by line. This may achieve the technical advantage that the line-by-line comparison of the encrypted lines of the first and second encrypted source code versions allows for a precise allocation between the first and second source code versions within the version identity via the line-by-line allocation of the encrypted lines of the first and second encrypted source code versions. The precise allocation of the individual lines of the first and second source code versions to each other makes it possible to assign the lines of the second source code version to the elements of the machine code. The precise allocation means that debugging may be carried out without any problems.

According to an embodiment, a match of an encryption of a line of the first encrypted source code version with an encryption of a line of the second encrypted source code version is interpreted as a complete match of the respective lines of the first and second source code versions. This has the technical advantage that the lines of the first source code version may be precisely assigned to the lines of the second source code version via the two encrypted source code versions. In this context, it is assumed that identical encryption is generated if the content of two lines is identical, while different encryption is to be expected if the content of the lines is different.

When comparing the encrypted lines of the first encrypted source code version with the encrypted lines of the second encrypted source code version, it may be assumed-if two encrypted lines match—that the respective unencrypted lines of the two source code versions also match. Similarly, if the encrypted lines differ, it may be assumed that the unencrypted contents of the lines of the two source code versions differ, as well. This allows for precisely allocating the two source code versions and thus a precise line-by-line allocation of the second source code version with the machine code.

According to an embodiment, the binary encryption is embodied as a hash value of the respective line. This has the technical advantage that the source code versions may be encrypted as simply as possible.

For example, a hash value may be determined by applying a function to the first source code version line by line to calculate hash values for the individual lines of the source code version. Such a function may be indicated, for example, by a secure hash function such as SHA-256.

According to an embodiment, the first machine code source code relation and the first source code identity are stored on a controller of the automation system, wherein the receiving step comprises copying the first machine code source code relation and the source code identity from the controller to the development system. This may achieve the technical advantage that the machine code source code relation or first source code identity stored on the controller of the automation system may be provided for the debugging process to be carried out on the development system.

According to an embodiment, the method further comprises:

providing a match information regarding a deviation and/or match of the first source code version and of the second source code version based on the comparison between the first and second encrypted source code versions in an information providing step.

This may achieve the technical advantage that the developer may be provided with precise information regarding matches or deviations between the second source code version handled by the developer and the first source code version corresponding to the machine code in question via the match information provided to the developer in the development system.

During the development process based on the second source code version, the developer usually does not have the first source code version. The developer may therefore use the provided match information to directly identify differences or matches between the two source code versions and adapt the debugging process accordingly. For example, the developer could refrain from placing holding points in lines of the second source code version that have been changed from the first source code version during the debugging process if the match information is taken into account. This simplifies the debugging process and speeds up the development process.

According to an embodiment, the match information marks lines in the second source code version that have been deleted or added in the second source code version compared to the first source code version. This has the technical advantage that by marking the added or deleted lines within the second source code version compared to the first source code version, the developer may immediately see changes in the second source code version so that these may be taken into account during the development process.

According to an embodiment, the match information is displayed in the development system to a user for executing the debugging process. This has the technical advantage that the development process may be simplified or accelerated because the developer may view the changes immediately. This may also increase the quality of the control program by enabling more precise debugging procedures and more efficient development processes.

According to an embodiment, the identity generating step comprises:
allocating first files comprising lines of the first source code version and/or lines of the first encrypted source code version with second files comprising lines of the second source code version and/or lines of the second encrypted source code version in a file association step, wherein at most one second file is allocated with each first file and at most one first file is allocated with each second file; and
comparing the lines of the first source code version and/or the first encrypted source code version of the first files with lines of the second source code version and/or the second encrypted source code version of the correspondingly assigned second files in a file comparing step.

This may achieve the technical advantage that the first and second source code versions are stored via the allocation of the files and that the corresponding comparisons of the files comprising the first and second source code versions allow for precisely allocating the individual lines of the first and second source code versions to each other and thus a precise version identity between the two first and second source code versions. This allows for a precise debugging process and improves the development process, which in turn may lead to improved and possibly safer control programs of the automation system.

According to an embodiment, the allocation of the first and second files in the file allocating step is carried out based on file paths of the respective first and second files or via a similarity of the lines and/or the encrypted lines of the first and second files, wherein the similarity is effected by executing a method for determining the Longest Common Partial sequence (LCS) on the lines of the first and second source code versions and/or the first and second encrypted source code versions stored in the first and second files. This has the technical advantage of allowing for precisely allocating the various files or a precise comparison of the files.

According to an embodiment, the comparison of the contents of the allocated first and second files is carried out by executing the method for determining the longest common partial sequence on the contents of the first and second files. This may achieve the technical advantage that by executing the method for determining the longest common partial sequence, a precise allocation of the encrypted lines of the first encrypted source code version and the encrypted lines of the second encrypted source code version is possible. This means that it is not necessary to decrypt the encrypted lines to create the allocation between the different source code versions.

According to an embodiment, executing the debugging process comprises:
upon receiving a holding point command from the user to set a holding point within the second source code version executed in the development system;
imaging a line in the second source code version, in which the holding point is to be set, to an address of the machine code based on the second machine code source code relation in an imaging step;
causing a hold in an execution of the machine code by the controller at an address of the machine code identified for the holding point in a program holding step;
imaging the address of the machine code at which the execution of the machine code is put on hold to the respective line of the second source code version based on the second machine code source code relation in a further allocating step; and
displaying the line of the second source code version, in which the execution of the machine code is put on hold, in the development environment in a displaying step.

This may achieve the technical advantage of allowing for a precise debugging process. When setting holding points within the second source code version, the allocation described above between the lines of the second source code version and the corresponding elements of the machine code may be used to ensure precise execution of the machine code and to stop the execution of the control program at the designated points.

According to a further aspect, an automation system comprising a controller and a development system is provided, wherein the automation system is arranged to execute the method for executing a debugging process of a control program of an automation system according to any one of the preceding embodiments.

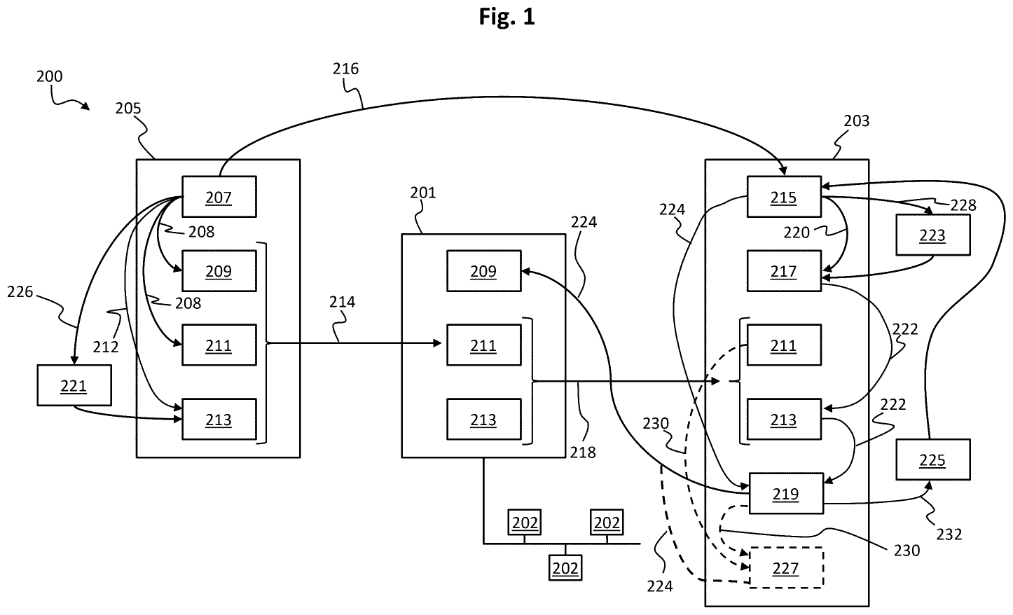

FIG. 1 shows a schematic depiction of an automation system 200. The automation system 200 shown comprises a controller 201 for executing a control program and controlling an automation process, and a plurality of sensor/actuator units 202 connected to the controller 201 for executing the automation process. In the embodiment shown, the automation system 200 further comprises two development systems 203, 205 for developing control programs for the automation system 200.

FIG. 1 shows a time sequence of a development process of a control program for an automation system 200. In this time sequence, the two development systems 203 and 205 shown carry out various processes for developing the control program, described in detail below, at different times. The processes carried out by the development system 203 are carried out at a later point in time than the processes carried out by the other development system 205.

The two development systems 203, 205 shown may actually represent different development systems that are operated, for example, by different developers and at different points in time. This shows the case in which different developers work simultaneously on the development of a shared control program and make changes to a jointly edited source code of the control program at different points in time.

As an alternative, the two development systems 203, 205 shown may represent a real identical development system at different points in time. This shows the case in which different source code versions are generated by a developer via the respective development system during a development process.

In FIG. 1, the other development system 205 describes the development system 203 at an earlier point in time. In the following, various steps of the method according to the application for executing a debugging process of a control program for an automation system 200 are illustrated with reference to FIG. 1.

First, a first version of a source code 207 of the control program to be programmed is generated on the development system 205 shown by a developer during a development process. In a translation process 208, a corresponding machine code 209 of the programmed control program is generated based on the first source code version 207.

Furthermore, a first machine code source code relation 211 is generated during the translation process 208. The first machine code source code relation 211 describes allocations between lines of the first source code version 207 and corresponding elements of the machine code 209.

In a first line identification process 212, a first source code identity 213 is further generated. Here, the first source code identity 213 comprises information relating to the first source code version 207, wherein the information of the first source code identity 213 allows for identifying individual lines of the first source code version 207.

For example, the first source code identity 213 may comprise the complete first source code version 207 or parts of the first source code version 207. The generation of the first source code identity 213 may be effected by an appropriately configured function or an appropriately configured algorithm. The function or the algorithm is in this context set up to read in the lines of the first source code version 207 and to output corresponding identification information of the respective lines.

As an alternative or in addition, a first encrypting process 226 may be used to encrypt the first source code version 207 and create a first encrypted source code version 221. The encryption may be carried out line by line by encrypting individual lines of the first source code version 207 and generating corresponding encrypted lines of the first encrypted source code version 221.

Line-by-line encryption may be achieved using an appropriately configured encryption function or an appropriately configured encryption algorithm. The function or algorithm is set up to encrypt the individual lines of the first source code version individually and to generate corresponding encrypted lines.

The line-by-line division of the first source code version 207 is maintained by the line-by-line encryption within the first encrypted source code version 221. The number of lines of the first encrypted source code version 221 corresponds to the number of lines of the first source code version 207. An i-th line of the first encrypted source code version 221 corresponds to an encryption of an i-th line of the first source code version 207. In this case, the first source code identity 213 may comprise the first encrypted source code version 221.

In an installation process 214, according to the application, the machine code 209 generated via the translation process 208, the first machine code source code relation 211 also generated via the translation process 208 and the first source code identity 213 generated via the first line identification process 212 or the first encrypting process 226 are installed on the controller 201 of the automation system 200. The installation of the machine code 209, the first machine code source code relation 211 and the first source code identity 213 on the controller 201 is effected by an appropriately set up installation function or an appropriately set up installation algorithm.

The controller 201 of the automation system 200 may, for example, be installed with a customer and a user of the automation system 200. Due to the encryption of the first source code version 207 and the correspondingly generated first encrypted source code version 221, the information of the source code within the first source code identity 213 installed on the controller 201 of the user cannot be read by unauthorized persons.

FIG. 1 now shows the case in which the first source code version 207 is changed to a second source code version 215 by a source code change operation 216, which is carried out by a developer by programming and making changes in the first source code version 207. This may have been done, for example, by adding or deleting individual lines of the first source code version 207.

In the diagram shown, the source code modification operation 216 or the subsequent operations carried out on the modified second source code version 215 are carried out by the development system 203. As mentioned above, the two development systems 203, 205 may be two real different development systems, for example executed by different developers during a simultaneous development process of the same control program.

Alternatively, the development systems 203, 205 may represent a real identical development system, which is merely executed at different times.

In order to carry out the debugging process 224 based on the second source code version 215 modified with respect to the first source code version 207, the first machine code source code relation 211 and the first source code identity 213 are first copied from the controller 201 to the development system 203 in a copy operation 218. Copying may be carried out using an appropriately configured copy function or an appropriately configured copy algorithm.

Further, in a second line identification process 220, a second source code identity 217 is generated based on the second source code version 215. The second source code identity 217 may comprise the complete second source code version 215 or parts of the second source code version 215, in analogy to the first source code identity 213.

The generation of the second source code identity 217 may be effected by an appropriately configured function or an appropriately configured algorithm. The function or the algorithm are in this context set up to read in the second source code version 215, identify individual lines and generate corresponding line information.

As an alternative or in addition, a second encrypted source code version 223 may be created in a second encrypting process 228 based on the second source code version 215. The encryption may in turn be effected by an appropriately configured encryption function or an appropriately configured encryption algorithm.

The second source code identity 217 may comprise the second encrypted source code version 223. The encryption may again be carried out line by line, so that the line division of the second source code version 215 is retained in the second encrypted source code version 223 and the second encrypted source code version 223 has encrypted lines that may each be assigned to the unencrypted lines of the second source code version 215.

The first source code identity 213 and the second source code identity 217 are preferably generated in an identical manner. The respective relations within the source code identities 213, 217 are in this context effected under the same aspects, so that there is comparability of the two source code identities 213, 217.

The encryption in the first and second encrypting processes 226, 228 may, for example, be formed as a binary encryption. For example, the binary encryption may be given by hash values by calculating corresponding hash values for individual lines of the first and second source code versions 207, 215. The encrypted lines of the first and second encrypted source code versions 221, 223 may each be represented in hash values calculated line by line.

In an identity generating process 222, a version identity 219 is generated based on the second source code identity 217 and the first source code identity 213. The version identity 219 describes allocations between the lines of the first source code version 207 and the lines of the second source code version 215.

The version identity 219 describes which lines of the second source code version 215 correspond to the lines of the first source code version 207 or identifies the lines of the second source code version 215 that do not correspond to the first source code version 207 due to changes and/or additions in the source code change process 216. Further, the version identity 219 may identify the lines of the first source code version 207 that have no correspondence to the second source code version 215 due to deletions and/or modifications during the source code modification process 216.

Here, the version identity 219 is generated by comparing the first and second source code identities 213, 217 with each other. If the first and second source code identities 213, 217 comprise the first and second encrypted source code versions 221, 223 generated by the encryption operations 226, 228, comparing the first and second source code identities 213, 217 comprises comparing the encrypted lines of the first and second encrypted source code versions 221, 223.

The generation of the version identity 219 may be effected by an appropriately set up function or an appropriately set up algorithm. The function or the algorithm are set up here to read in the first and second source code versions 207, 215 and to identify lines of the first source code version 207 that are contained in the second source code version 215 in an unmodified form. In addition, the function or the algorithm may be set up to identify lines of the second source text version that do not occur in the first source text version 207 and/or to identify lines of the first source text version 207 that do not occur in the second source text version 215 in an unmodified form.

As an alternative or in addition, the function or algorithm may be arranged to be applied to the first and second encrypted source code versions 221, 223 and to identify encrypted lines of the first encrypted source code version 221 that occur unchanged or do not occur in the second encrypted source code version 223, or to identify encrypted lines of the second encrypted source code version 223 that have no correspondence in the first encrypted source code version 221.

It is not necessary to decrypt the encrypted lines of the first and second encrypted source code versions 221, 223. Instead, it is assumed that if the lines of the first and second source code versions 207, 215 are encrypted line by line, the lines with identical content are encrypted identically, while the encrypted lines with different content also have a different encrypted value.

In this context, the encryptions of the first and second source code versions 207, 215 are executed in the two encrypting processes 226, 228 using the same encryption key. When encrypting the individual lines by calculating a hash value, it is therefore assumed that the same hash value is calculated for lines with identical content, while lines with different content result in different hash values.

Comparing the encrypted lines of the first and second encrypted source code versions 221, 223 of the first and second source code identities 213, 217 may be effected, for example, by executing a longest common partial sequence (LCS) determination method as part of a difference (diff) tool. For this purpose, a method known in the prior art for determining the longest common partial sequence may be applied and executed on the respective encrypted lines of the first and second encrypted source code versions 221, 223 to determine the above-mentioned allocations between the encrypted lines of the first and second encrypted source code versions 221, 223.

Based on the first machine code source code relation 211 and the generated version identity 219, a second machine code source code relation 227 is determined in a relation generating process 230. The dotted line depiction illustrates that in order to determine the second machine code source code relation 227, it is optional to generate a corresponding file comprising the addressed second machine code source code relation 227.

The second machine code source code relation 227 may be executed by an appropriately set up function or algorithm. The function or the algorithm may be set up here to read in the first machine code source code relation 211 and the version identity 219, to determine from the first machine code source code relation 211 which lines of the first source code version 207 correspond to which code elements of the machine code 209. The function or algorithm is further configured to read in the version identity 219 and determine which lines of the first source code version 207 correspond to which lines of the second source code version 215. Based on the information of the first machine code source code relation 211 and the version identity 219, the function or the algorithm is furthermore set up to determine which lines of the second source code version 215 correspond to which code elements of the machine code 209 and to set up corresponding relations. The relations may be stored as second machine code source code relation 227 in a corresponding file.

Alternatively, the allocations described in the second machine code source code relation 227 between the lines of the second source code version 215 and the respective elements of the machine code 209 may be determined without storage in a corresponding file only for the respective execution of the debugging process 224 for the respective lines of the second source code version 215.

In order to determine the allocations between the lines of the second source code version 215 and the corresponding elements of the machine code 209, the allocations between the lines of the second source code version 215 and the lines of the first source code version 207 are first determined based on the version identity 219. As already described, these allocations may be effected indirectly via the respective encrypted lines of the second encrypted source code versions 221, 223 by first determining the allocations between the encrypted lines of the first and second encrypted source code versions 221, 223 and, based thereon, determining the allocations between the corresponding unencrypted lines of the first and second source code versions 207, 215.

Based on the determined allocations between the lines of the first and second source code versions 207, 215 of the version identity 219, the corresponding allocations between the lines of the second source code version 215 and the respective elements of the machine code 209 may be determined in the form of the second machine code source code relation 227, taking into account the first machine code source code relation 211, which defines which lines of the first source code version 207 correspond to which elements of the machine code 209.

Based on the version identity 219 and taking into account the second machine code source code relation 227, the debugging process 224 of the control program may be executed in the following based on the second source code version 215 and the machine code 209 stored on the controller 201. By taking into account the second machine code source code relation 227, the execution of the machine code 209 may be effected based on the second source code version 215 despite deviations of the second source code version 215 from the first source code version 207 and may additionally be traced in the debugging process 224.

Thus, as is usual in debugging processes, holding points may be set within the second source code version 215 and the control program may be stopped at the desired points based on the machine code 209, taking into account the second machine code source code relation 227.

In order to better identify the changes of the second source code version 215 with respect to the first source code version 207, a match information 225 may be provided in a match providing process 232. Here, the match information 225 provides matches or changes between the second source code version 215 with respect to the first source code version 207.

The match information 225 may be visually displayed to the developer in the development system 203, for example, by highlighting the matched or modified lines of the second source code version 215.

The generation and provision of the matching information 225 may be carried out by a correspondingly configured function or algorithm. The function or the algorithm is in this context set up to read in the version identity 219 and, based on this, to determine matches and/or deviations of lines of the first source code version 207 and the second source code version 215 and to provide this information in the match information 225.

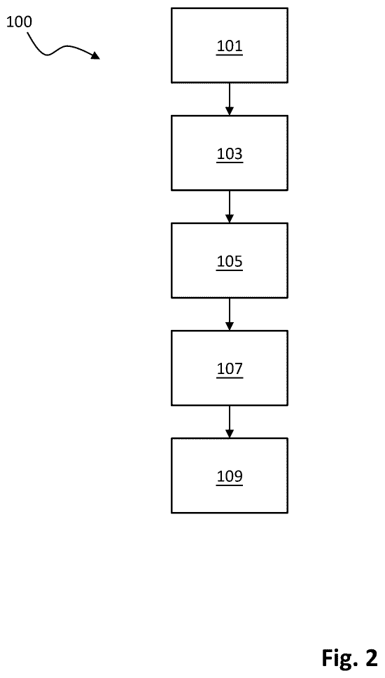

FIG. 2 shows a flowchart of a method 100 for executing a debugging process 224 according to an embodiment. In order to carry out a debugging process 224, a first machine code source code relation 211 and a first source code identity 213 are first received by a development system 203 in a receiving step 101. To this end, a copy operation 218 may be carried out in which the first machine code source code relation 211 and the first source code identity 213 are copied to the development system 203. This copying may be realized by a function appropriately set up for copying data.

As described in FIG. 1, the first machine code source code relation 211 and the first source code identity 213 may be previously stored on a controller 201 of an automation system 200. As also already described with respect to FIG. 1, the first machine code source code relation 211 describes allocations between lines of a first version of a source code 207 of a control program of the automation system 200 and elements of an allocated machine code 209. The first source code identity 213, on the other hand, comprises information relating to the first source code version 207 that allows identifications of individual lines of the first source code version 207.

According to an embodiment, the first source code identity 213 may comprise the first source code version 207 or portions of the first source code version 207. In a source code comparing step 103, the copied first source code identity 213 is compared with a second source code identity 217 of a second source code version 215 executed on the development system 203. Here, the second source code identity 217 is based on the second source code version 215 and may comprise the second source code version 215 in its entirety or parts of the second source code version 215.

As already described above, the second source code version 215 is based on the first source code version 207 and is the result of source code changes in the form of the addition or deletion of individual lines of source code. The comparison of the first and second source code identities 213, 217 may be carried out line-by-line, wherein the comparison determines which lines of the second source code version 215 match lines of the first source code version 207 or which lines have no correspondence to the first source code version 207.

In an identity generating step 105, a version identity 219 is generated based on the comparisons between the first and second source code identities 213, 217. The version identity 219 describes allocations between lines of the first source code version 207 and lines of the second source code version 215.

The version identity 219 thus defines which lines of the second source code version 215 correspond to lines of the first source code version 207 and which lines of the second source code version 215 have no correspondence in the first source code version 207. For the matching lines of the second source code version 215, it is also defined with which lines of the first source code version 207 there is a match.

In a relation determining step 107, a second machine code source code relation 227 is determined based on the first machine code source code relation 211 and the version identity 219. The second machine code source code relation 227 defines allocations between the lines of the second source code version 215 and the elements of the machine code 209.

In a debugging step 109, a debugging process 224 of the control program is subsequently carried out using the machine code 209 stored on the controller 201 of the automation system 200, taking into account the second machine code source code relation 227 based on the second source code version 215.

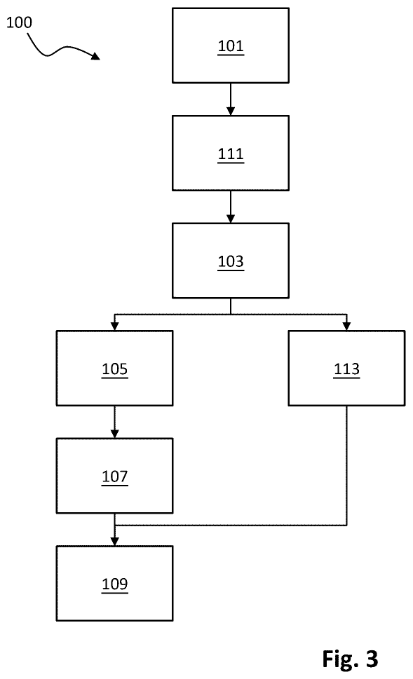

FIG. 3 shows a further flowchart of the method 100 for executing a debugging process 224 according to a further embodiment. The embodiment of the method 100 shown in FIG. 3 is based on the embodiment in FIG. 2 and comprises all the method steps described therein. If these are the same in the embodiment shown, a further detailed description is not provided.

In contrast to the embodiment in FIG. 2, in the embodiment in FIG. 3 the second source code version 215 is first encrypted in an encrypting step 111 and a second encrypted source code version 223 is generated. Similarly, a corresponding encryption of the first source code version 207 was previously carried out and a corresponding first encrypted source code version 221 was generated. The first encrypted source code version 221 was accordingly taken into account in the first source code identity 213 and stored on the controller 201 of the automation system 200.

The encryptions of the first and second source code versions 207, 215 may be carried out line by line by transferring individual lines of the first and second source code versions 207, 215 into corresponding encrypted lines of the first and second encrypted source code versions 221, 223. The line-by-line encryption preserves the line structure of the first and second source code versions 207, 215.

According to an embodiment, the encryption may, for example, be embodied as a binary encryption. For this purpose, for example, hash values may be calculated for the line-by-line encryption for individual lines of the first and second source code versions 207, 215. Accordingly, an identical key is used in the encrypting processes 226, 228 of the first and second source code versions 207, 215, so that a comparable encryption of the individual lines of the different source code versions is possible.

Analogously to the first source code identity 213, in the embodiment shown the second source code identity 217 is generated based on the second encrypted source code version 223. Accordingly, in the source code comparing step 103, the encrypted lines of the first and second encrypted source code versions 221, 223 of the first and second source code identities 213, 217 are compared with each other.

For this purpose, no decryption of the encrypted lines of the first and second encrypted source code versions 221, 223 needs to be carried out. Instead, the comparison may be carried out on the encrypted lines of the encrypted source code versions 221, 223.

In this context, it is assumed that identical encryption is generated for lines with identical content, while lines with different content result in different encrypted lines. The comparison of the encrypted lines of the first and second encrypted source code versions 221, 223 may be effected, for example, by executing a method known in the prior art for determining the longest common partial sequence on the encrypted lines of the respective encrypted source code versions.

By executing the method for determining the longest common partial sequence, an exact allocation of the encrypted lines of the second encrypted source code version 223 to the encrypted lines of the first encrypted source code version 221 may be carried out. Here, it is possible to clearly allocate which encrypted line of the first encrypted source code version 221 corresponds to an encrypted line of the second encrypted source code version 223.

Based on the comparison of the first and second encrypted source code versions 221, 223, the version identity 219 is generated in the identity generating step 105. As already explained above, this describes allocations between the lines of the first source code version 207 and the second source code version 215. In this context, use is made of the fact that the line structure is retained during line-by-line encryption of the first and second source code versions 207, 215.

This means that a first encrypted line of an encrypted source code version corresponds to an encryption of a first unencrypted line of the corresponding unencrypted source code version. The line numbers of the respective encrypted and unencrypted lines are the same.

The allocations between the encrypted lines of the first and second encrypted source code versions 221, 223 may thus be used to infer the corresponding allocations of the unencrypted lines of the first and second source code versions 207, 215. The version identity 219 generated based on the first and second encrypted source code versions 221, 223 thus corresponds to the version identity 219 calculated on the first and second source code versions 207, 215 in the embodiment described above.

Furthermore, in the embodiment shown, a match information 225 is provided in an information providing step 113. In the match information 225, lines of the second source code version 215 are defined that match lines of the first source code version 207 or lines that do not match any line of the first source code version 207. Furthermore, the lines of the first source code version 207 that are deleted in the second source code version 215 may be displayed or marked. The marking may include the actual deleted line and/or the line number of the deleted line and/or the number of deleted lines. The match information 225 may be displayed to a developer by markings in the second source code version 215.

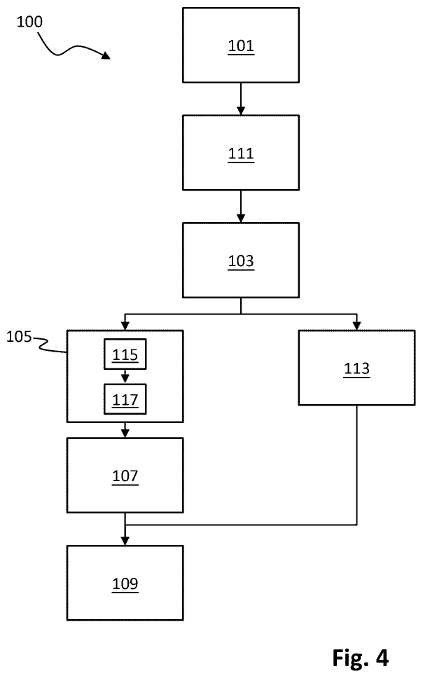

FIG. 4 shows a further flowchart of the method 100 for executing a debugging process 224 according to a further embodiment. The embodiment shown in FIG. 4 is based on the embodiment in FIG. 3 and comprises all the method steps described therein.

In contrast to the embodiment in FIG. 3, in the embodiment shown in FIG. 4, in the identity generating step 105 first files comprising contents of the first source code version 207 or the first encrypted source code version 221 are first allocated to second files comprising contents of the second source code version 215 or the second encrypted source code version 223 in a file allocating step 115. A maximum of one second file is allocated to each first file and a maximum of one first file is allocated to each second file.

According to an embodiment, the allocation of the first and second files may be effected based on file paths of the respective first and second files. As an alternative or in addition, the allocations of the first and second files may be carried out taking into account the respective contents of the first and second files. For example, the method described above for determining the longest common partial sequence may be used for this purpose.

In a file comparing step 117, the first and second files allocated to each other are compared with each other. For this purpose, the method already mentioned for determining the longest common partial sequence for the respective contents of the first and second files assigned to each other may again be used.

The method for determining the longest common partial sequence thus allows the first and second files assigned to each other to be compared and first and second files comprising identical or similar content to be recognized. The file association and the file comparison may be used to result in the generation of the version identity 219 described above by using the described comparison of the contents of the files, which comprise in particular the already described unencrypted lines of the first and second source code versions 207, 215 and the encrypted lines of the first and second encrypted source code versions 221, 223, respectively.

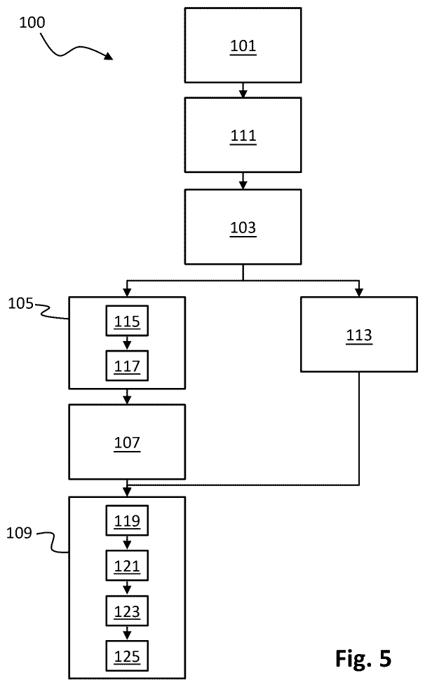

FIG. 5 shows a further flowchart of the method 100 for executing a debugging process 224 according to a further embodiment. The embodiment shown in FIG. 5 is based on the embodiment in FIG. 4 and comprises all the method steps described there.

In the embodiment shown, in order to carry out the debugging process 224 in the debugging step 109, first, in an allocating step 119, upon receiving a holding point instruction from the user of the development system 203 to set a holding point within the second source code version 215 executed or displayed in the development system 203, a line in the second source code version 215 in which the holding point is to be set is mapped to an address or element of the machine code 209 based on the second machine code source code relation 227. This is used to allocate the corresponding allocated element of the machine code 209 to the respective line of the second source code version 215 in accordance with the second machine code source code relation 227.

In a program holding step 121, a holding point in an execution of the machine code 209 is caused by the controller 201 in the address identified for the holding point or in the element of the machine code 209. According to the set holding point, the controller is put on hold as in a usual debugging process 224 or the execution of the control program is put on hold at the location identified by the holding point as soon as the execution of the machine code 209 reaches the holding point.

In a further allocating step 123, the respective address or element of the machine code 209 at which the execution of the machine code 209 or the control program is put on hold is mapped to the respective line of the second source code version 215 based on the second machine code source code relation 227. This may also be done for locations in the machine code 209 at which no holding point was set, but which were transferred to the second source code version 215 by the second machine code source code relation 227.

As in a usual debugging process 224, the user or developer in the development system 203 is shown the respective line within the executed source code of the second source code version 215 at which the execution of the control program or the allocated machine code 209 was put on hold. This is achieved via the second machine code source code relation 227 generated as described above, in which the respective elements of the machine code 209 are assigned to individual lines of the second source code version 215.

In a displaying step 125, the line of the second source code version 215, in which the execution of the machine code 209 is put on hold, is displayed in the development system 203 to the respective developer.

As has been described with respect to the above embodiments, the method 100 according to the application for executing a debugging process 224 of a control program of an automation system 200 may execute debugging of a control program based on a version of a source code that does not correspond to the source code version on which a corresponding machine code 209 of the control program has been generated based on a translation process and is executed on the controller 201.

As a result, debugging process 224 may be carried out without having to carry out a retranslation of the source code into a corresponding machine code 209 and an update of the machine code 209 on the controller 201 during the development process of the control program each time the source code is changed, including a restart of the execution of the control program on the controller 201.

The method 100 according to the application according to the embodiments described above may be executed by a corresponding execution module. The execution module may, for example, be executed by a development system 203 during a programming process or for executing a translation process or debugging process. The execution module may, for example, be integrated into the development system for this purpose.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
Figure references

100 Method
101 Receiving step
103 Source code comparing step
105 Identify generating step
107 Relation determining step
109 Debugging step
111 Encrypting step
113 Information providing step
115 File allocating step
117 File comparing step
119 Imaging step
121 Program holding step
123 Further imaging step
125 Displaying step
200 Automation system
201 Controller
202 Sensor/actuator unit
203 Development system
205 Further development system
207 First source code version
208 Translation process
209 Machine code
211 First machine code source code relation
212 First line identification process
213 First source code identity
214 Installation process
215 Second source code version
216 Source code change process
217 Second source code identity
218 Copying process
219 Version identity
220 Second line identification process
221 First encrypted source code version
222 Identity generating process
223 Second encrypted source code version
224 Debugging process
225 Match information
226 First encrypting process
227 Second machine code source code relation
228 Second encrypting process
230 Relation generating process
232 Match providing process

1. A method for executing a debugging process of a control program of an automation system, comprising:
receiving a first machine code source code relation and a first source code identity by a development system for executing the debugging process, in a receiving step,
wherein the first machine code source code relation defines allocations between lines of a first source code version of the control program and corresponding code elements of a machine code of the control program generated by translating the first source code version, and
wherein the first source code identity comprises information relating to the first source code version that allows for identifying individual lines of the first source code version;
comparing the first source code identity with a second source code identity of a second source code version executed on the development system, in a source code comparing step,
wherein the second source code version has emerged from the first source code version by at least one source code change, and
wherein the second source code identity comprises information relating to the second source code version which allows for identifying individual lines of the second source code version;
generating a version identity based on the comparison of the first source code identity and the second source code identity, in an identity generating step,
wherein the version identity defines allocations between lines of the first source code version and lines of the second source code version corresponding to the lines of the first source code version;
determining a second machine code source code relation based on the first machine code source code relation and the version identity, in a relation determining step,
wherein the second machine code source code relation defines allocations between lines of the second source code version and corresponding code elements of the machine code; and
executing the debugging process of the machine code stored on the controller based on the second source code version using the second machine code source code relation, in a debugging step.

2. The method according to claim 1, wherein the first source code identity comprises the first source code version and the second source code identity comprises the second source code version.

3. The method according to claim 1, wherein:
the first source code identity comprises a first encrypted source code version based on an encryption of the first source code version; and
wherein the method further comprises:
encrypting the second source code version and generating a second encrypted source code version, in an encrypting step,
wherein the second source code identity comprises the second encrypted source code version; and
wherein comparing the first and second source code identities comprises comparing the first and second encrypted source code versions.

4. The method according to claim 3, wherein the encrypting of the first and second source code versions is carried out line by line.

5. The method according to claim 3, wherein the encryption of the first and second source code versions is configured as a binary encryption.

6. The method according to claim 3, wherein comparing the first and second encrypted source code versions in the identity generating step comprises comparing the encrypted lines of the first and second encrypted source code versions line by line.

7. The method according to claim 6, wherein a match of an encryption of a line of the first encrypted source code version with an encryption of a line of the second encrypted source code version is interpreted as a complete match of the respective lines of the first and second source code versions.

8. The method according to claim 5, wherein the binary encryption is formed as a hash value of the respective row.

9. The method according to claim 1, wherein:
the first machine code source code relation and the first source code identity are stored on a controller of the automation system, and
wherein the receiving step comprises copying the first machine code source code relation and the first source code identity from the controller to the development system.

10. The method according to claim 1, further comprising:
providing a match information regarding a deviation and/or match of the first source code version and of the second source code version based on the comparison between the first and second encrypted source code versions, in an information providing step.

11. The method according to claim 10, wherein the match information marks lines in the second source code version that have been deleted or added in the second source code version with respect to the first source code version.

12. The method according to claim 10, wherein the match information in the development system is displayed to a user for executing the debugging process.

13. The method according to claim 1, wherein the identity generating step comprises:
allocating first files comprising lines of the first source code version and/or lines of the first encrypted source code version with second files comprising lines of the second source code version and/or lines of the second encrypted source code version, in a file allocating step,
wherein at most one second file is allocated to each first file and at most one first file is allocated to each second file; and
comparing the lines of the first source code version and/or the first encrypted source code version of the first files with lines of the second source code version and/or the second encrypted source code version of the correspondingly allocated second files, in a file comparing step.

14. The method according to claim 13, wherein:
the allocation of the first and second files in the file allocating step is carried out based on file paths of the respective first and second files or via a similarity of the lines and/or the encoded lines of the first and second files, and
wherein the similarity is effected by executing a method for determining the Longest Common Partial sequence (LCS) on the lines of the first and second source code versions and/or the first and second encrypted source code versions stored in the first and second files.

15. The method according to claim 13, wherein the comparing of the contents of the allocated first and second files is carried out by executing the method for determining the longest common partial sequence on the contents of the first and second files.

16. The method according to claim 1, wherein executing the debugging process comprises:
upon receiving a holding point command from the user to set a holding point within the second source code version executed in the development system;
imaging a line in the second source code version, in which the holding point is to be set, to an address of the machine code based on the second machine code source code relation, in an imaging step;
causing a hold in an execution of the machine code by the controller at an address of the machine code identified for the halt point, in a program holding step;
imaging the address of the machine code at which the execution of the machine code is put on hold to the respective line of the second source code version based on the second machine code source code relation, in a further imaging step; and
displaying the line of the second source code version, in which the execution of the machine code is put on hold, in the development environment, in a displaying step.
